(19) United States
(12) Patent Application Publication
(10) Pub. No.: US 2023/0165179 A1
(43) Pub. Date: Jun. 1, 2023

(54) MOBILE SOIL CULTIVATION APPLIANCE WITH COUNTERBALANCE WEIGHT

(71) Applicant: Wiedenmann GmbH, Rammingen (DE)

(72) Inventors: Thomas JUNGINGER, Blaustein-Bermaringen (DE); Volker ZIPPEL, Holldorf (DE); Ralph WIEDENMANN, Herbrechtingen (DE); Andreas JUNGINGER, Asselfingen (DE); Martin WINKLER, Ulm (DE); Sebastian HOLZBERGER, Niederstoltzingen (DE); Karin WÖRZ, Weidenstetten (DE); Uwe WIEDENMANN, Rammingen (DE)

(21) Appl. No.: 18/072,904

(22) Filed: Dec. 1, 2022

(30) Foreign Application Priority Data
Dec. 1, 2021 (DE) 10 2021 131 679.0
Dec. 1, 2021 (DE) 10 2021 131 681.2
Dec. 1, 2021 (DE) 10 2021 131 682.0
Dec. 16, 2021 (DE) 10 2021 133 545.0
Jan. 11, 2022 (DE) 10 2022 100 539.9

(51) Int. Cl. A01B 45/02

(52) U.S. Cl. CPC A01B 45/023; A01B 76/00

(57) ABSTRACT

A mobile soil cultivation appliance includes a chassis with at least one drive axle for driving a travel movement of the soil cultivation appliance over the soil, a drive unit with a drive shaft, a work implement which is configured to be ascended and descended relative to the chassis and includes a drive shaft and at least one soil working tool which is movable for soil working upon rotation of the drive shaft. The drive shaft is connected to the output shaft by means of a power transmission means to allow the drive shaft to be driven by the drive unit, and the drive unit is connected to the work implement as a counterweight for the work implement in such a way that the drive unit descends when the work implement is ascended and ascends when the work implement is descended.

### CROSS-REFERENCE TO RELATED APPLICATIONS

This application claims priority from German Application No. DE 10 2021 131 681.2 filed Dec. 1, 2021; German Application No. DE 10 2021 131 682.0 filed Dec. 1, 2021; German Application No. DE 10 2021 131 679.0 filed Dec. 1, 2021; German Application No. DE 10 2021 133 545.0 filed Dec. 16, 2021; and German Application No. DE 10 2022 100 539.9 filed Jan. 11, 2022. The aforementioned applications are incorporated herein by reference in their entireties.

### TECHNICAL FIELD

The invention relates to a mobile soil cultivation appliance for cultivating soil. More particularly, the invention relates to a soil cultivation appliance for lawn care such as, in particular, a deep aerator or aerator or a mower.

### RELATED ART

For the technological background, reference is made in particular to the following literature:

### [1] DE 10 2018 114 882 A1

[2] U.S. Pat. No. 7,096,969 B2

### [3] DE 10 2014 104 876 A1

### [4] DE 10 2008 017 242 A1

### [5] DE 10 2005 055 289 B3

### [6] DE 10 2005 021 025 A1

### [7] DE 10 2004 018 591 A1

### [8] DE 10 2011 080 385 B3

### SUMMARY

The object of the invention is to improve a mobile soil cultivation appliance in terms of function and more cost-effective design.

To solve this object, the invention provides a soil cultivation appliance according to the independent claims.

Advantageous embodiments are the subject-matter of the dependent claims.

According to one aspect thereof, the invention provides a mobile, in particular self-propelled, soil cultivation appliance comprising

a chassis with at least one drive axle for driving a travel movement of the soil cultivation appliance over the soil,

a drive unit with an output shaft,

a driven work implement which is raisable and lowerable relative to the chassis and comprises a drive shaft and at least one soil working tool which is movable for soil working upon rotation of the drive shaft, wherein the drive shaft is connected to the output shaft by means of a power transmission means so as to be drivable by the drive unit,

wherein the drive unit is connected to the work implement as a counterweight for the work implement in such a way that the drive unit lowers when the work implement is raised and raises when the work implement is lowered.

It is preferred, that the drive axle has a first and a second drive wheel and is connected to a traction drive unit that is set up to drive the first and the second drive wheel at different speeds and/or in the same or different directions of rotation.

It is preferred that the chassis has at least one swivel wheel which is arranged at a distance from the drive axle with respect to a direction of travel.

It is preferred that the drive shaft or drive wheels thereof are driven by means of at least one traction motor designed as an electric motor or hydraulic motor.

It is preferred that the drive unit has an internal combustion engine.

It is preferred that the drive unit has a fuel tank.

In another embodiment, it is provided that the drive unit comprises a rechargeable battery and/or an electric motor.

It is preferred that the work implement has a series of piercing tools with tines that can be driven into the ground and pulled out by means of the drive shaft for deep lifting.

It is preferred that the drive unit on the one hand and the work implement or a work implement linkage for steering the work implement on the other hand are arranged on different sides of the drive axle.

It is preferred that the drive unit and the work implement or its work implement linkage are arranged on a rocker structure, which is pivotally linked to the chassis relative to the chassis.

It is preferred that the rocker construction has at least one first two-sided lever which is articulated to the chassis and to one lever arm of which the drive unit is articulated and to the other lever arm of which the work implement or work implement linkage is articulated, and a second two-sided lever which is articulated to the chassis at a vertical distance from the first two-sided lever the first lever arm of which is articulated to the drive unit at a vertical distance from the first lever arm of the first two-sided lever and the second lever arm of which is articulated to the work implement or its work implement linkage at a vertical distance from the second lever arm of the first two-sided lever.

It is preferably that the power transmission means comprises at least one drive belt.

It is preferred that a lifting actuator is provided for lifting and lowering the work implement and/or its work implement linkage. It is preferred that the lifting actuator is designed as an electrically or hydraulically driven cylinder.

It is preferably that the drive unit comprises a generator for producing electricity.

It is preferred that the work implement has at least one support wheel for supporting the work implement on the ground.

It is preferred that the soil cultivation work implement is designed as a remotely operable self-propelled soil cultivation work implement and/or as a self-propelled soil cultivation work implement for operation by an operator traveling with the work implement.

The work implement is preferably a deep aerator as described and shown in one of the literatures [3] to [7]. Such a deep aerator is in particular designed as an aerating head, which is further preferably designed with a series of piercing tools, which are hinged to support arms, which can be moved up and down by means of a crankshaft (example for drive shaft). The work implement could also be a mower as described and shown, for example, in reference [8]. In use during soil cultivation, the i work implement is operated in a lowered position. In this context, according to a preferred embodiment, the work implement, which is supported on the ground in particular via a support roller, can also move vertically relative to the chassis when traveling over the ground, depending on the nature and contour of the ground. During transfer travel, the working implement is transferred to a raised position so that tools do not drag on the ground. For this purpose, in particular, a lifting actuator is provided by means of which a work implement linkage, for example designed as a triangular linkage as used on tractors, can be moved up and down. It is advantageous if the lifting forces of the lifting actuator are kept low. If only low lifting forces occur, a smaller-dimensioned lifting actuator can be used. For example, electrically operated lifting cylinders can be used. This can be achieved with particularly preferred embodiments of the invention.

The drive shaft is preferably driven by means of a belt drive, in which the power transmission means has at least one drive belt. The belt drive has the advantage that a certain amount of slippage is permitted in the event of overload—for example when a tool strikes a stone or the like. It is advantageous if the distance between the input shaft and the output shaft remains the same even with different vertical relative positions between the work implement and the undercarriage. This can be achieved with particularly preferred embodiments of the invention.

Particularly in the case of deep aerators, it is advantageous if the piercing tools, which are in particular designed with tines, are guided in such a way that the tines move in and out as vertically as possible at the headland. This can be achieved with particularly preferred embodiments of the invention.

In particularly preferred embodiments of the invention, the aerating head or the other work implement or its work implement linkage is guided via a rocker, with a drive unit, in particular a drive motor, acting as a counterweight.

Particularly preferred embodiments have one or more of the following advantages:
Use of the drive motor, in particular the internal combustion engine, to relieve the lifting actuator system
no change in length in the belt drive or the other power transmission means due to the lifting process
Decoupling of the vibrations in the drive against the chassis possible by means of central bearings

Preferably, the aerator head or other work implement is attached to a movable connecting element, with the pivot point relative to a chassis—example for chassis—being as close as possible to the axle of the drive wheels.

In order to keep the lifting force of the cylinders as low as possible, the main drive unit—e.g. combustion engine—acts as a counterweight.

Positioning the motor and aerator head on a fixed component always ensures the same belt tension.

When raising and lowering the aerator head, the drive unit—e.g. the main motor is raised or lowered in the corresponding opposite direction.

Connecting element can be designed with one axis as a rocker or with several axes as a parallelogram.

Since driving the work implement requires considerably more energy than driving or lifting, it is currently preferred that the drive unit has an internal combustion engine for supplying the drive power for the implement. A fuel tank may also be provided on the drive unit. Alternatively, a battery for an electric motor may be provided as a counterweight, and the electric motor may also be part of the drive unit.

The drive unit preferably provides primary motive power for the drive unit. Preferably, a generator is further provided to supply power for secondary drives. The undercarriage is preferably provided with traction motors which operate electrically, and likewise the lifting actuator is preferably operated electrically.

### BRIEF DESCRIPTION OF THE DRAWINGS

Examples of embodiments are explained in more detail below with reference to the accompanying drawings. Therein shows:

FIG. 1 a schematized side view of a first embodiment of a mobile soil cultivation appliance with a work implement in a raised position;

FIG. 2 a further side view of the first embodiment of the soil cultivation appliance, wherein the work implement is arranged in an upper position;

FIG. 3 a view comparable to FIGS. 1 and 2, in which the work implement is arranged in a central position;

FIG. 4 a view comparable to FIGS. 1-3, in which the work implement is arranged in a lower position;

FIG. 5 a schematized side view of a second embodiment of the mobile soil cultivation appliance, wherein a work implement is arranged in a raised position;

FIG. 6 schematic side view of a third embodiment of a mobile soil cultivation appliance with a work implement in a raised position; and

FIG. 7 another side view of the third embodiment, with the work implement arranged in a central position as in FIG. 3.

### DETAILED DESCRIPTION

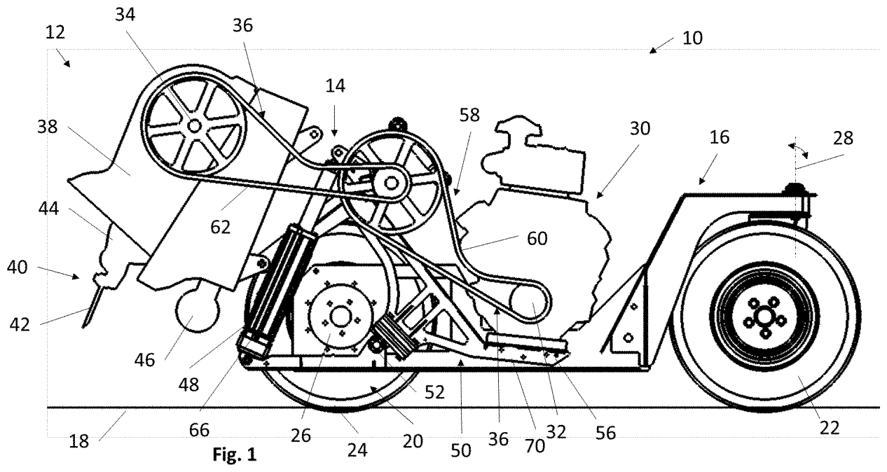

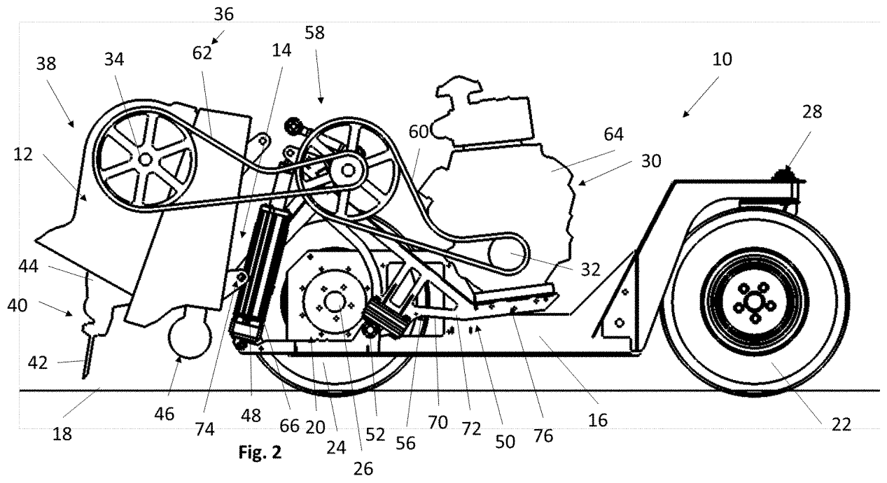

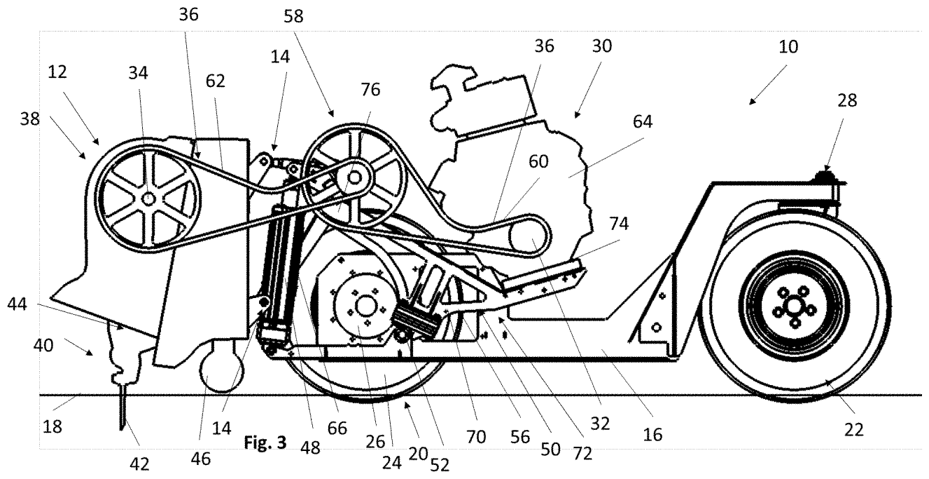

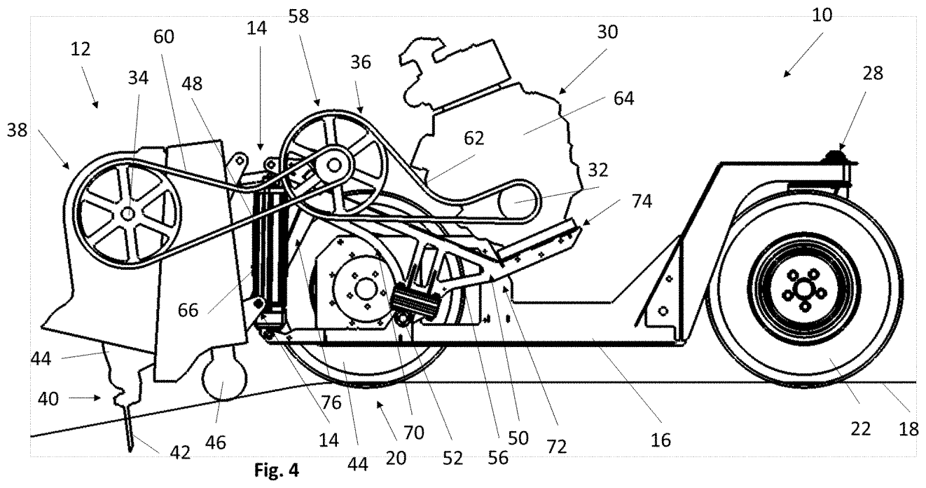

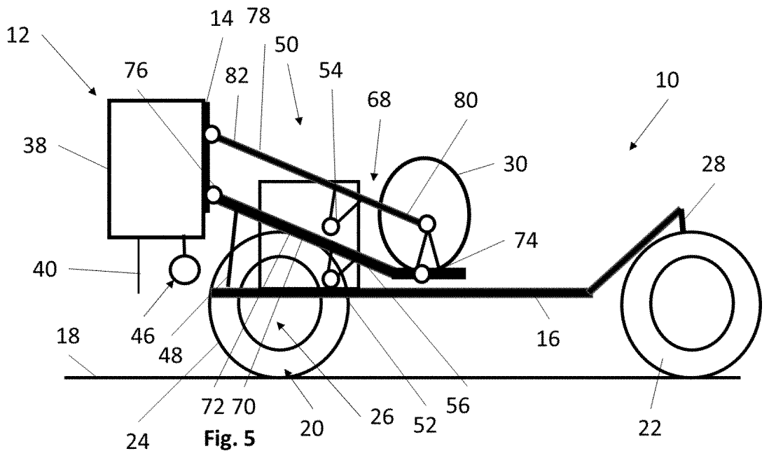

The attached figures show different embodiments of a mobile, in particular self-propelled, soil cultivation appliance 10. The soil cultivation appliance 10 is designed for cultivating a soil provided in particular with lawn. In particular, the soil cultivation appliance 10 is designed for lawn care. For this purpose, the soil cultivation appliance has a work implement 12, which is articulated here to a working implement linkage 14 and can be lifted out in a transport position shown in FIGS. 1 and 5 and can be arranged in various vertical positions relative to a chassis 16 of the soil cultivation appliance 10 in working positions shown in FIGS. 2-4.

For driving over the ground 18, the soil cultivation appliance 10 has the chassis 16, which has at least one drive axle 20 and at least one support element that is variable actively or passively with respect to the direction of travel, such as in particular at least one swivel wheel 22. The chassis 16 may, for example, have two axles, one of which is driven as the drive axle 20, and the other of which is designed for steering. The soil cultivation appliance 10 may be of three-wheeled or four-wheeled design, also all axles may be driven. Also, all wheels may be steerable. In the preferred embodiment, a drive axle 20 is provided with drive wheels 24 which can be driven at different speeds or also with different drive directions by means of a traction drive unit and their own traction motors 26 per drive wheel 24, while a swivel wheel 22, which is preferably arranged at the front, can be freely rotated about a swivel axis 28 extending substantially vertically. Thus, by driving the drive wheels 24 at different speeds or in different directions, steering or rotation of the chassis 16 can be affected.

Further, the soil cultivation appliance 10 has a drive unit 30 with an output shaft 32. The work implement 12 is a work implement 12 driven by the drive unit 30 and has a drive shaft 34 which is connected to the output shaft 32 by means of a power transmission means 36.

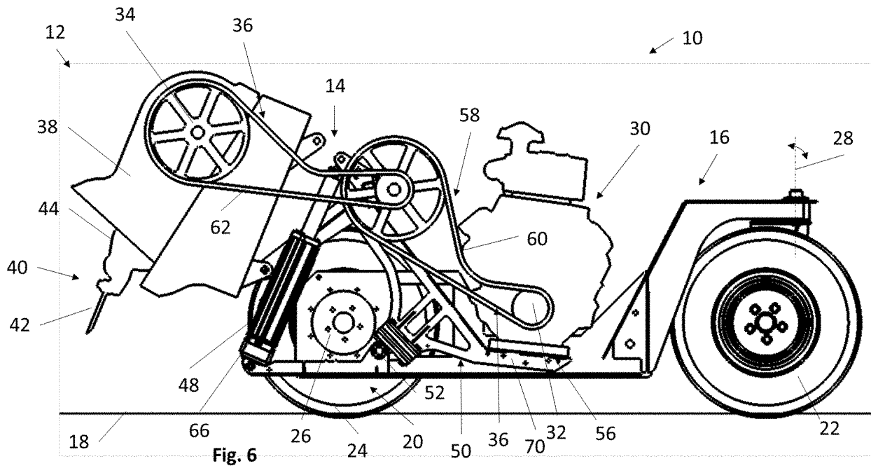

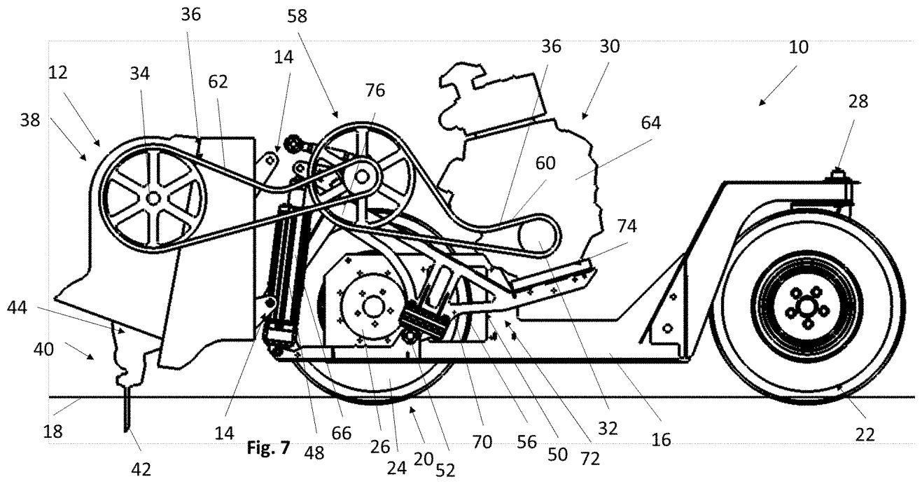

The work implement 12 is designed, for example, as a deep aerator 38, as described and shown in the literatures [3]-[7] or also in the literature [1]. Reference is made to these printed materials for further details. As is known, for example, from these printed publications, the deep aerator 38, which can also be referred to as an aerator head, has a series of piercing tools 40 with tines 42 which can be moved up and down, for example guided on support arms 44, in order to stab the tines 42 into the ground 18, to be pivoted therein and then to be pulled out of the ground 18 again. This results in deep loosening of the soil below the turf. The support arms 44 are driven, as described, and shown in the aforementioned literature [1], [3]-[7], for example, via the drive shaft 34 designed as a crankshaft. In the embodiments shown in FIGS. 1 to 5, at least one preferably height-adjustable support roller 46 is provided on the work implement 12. In the design as a deep aerator 38, the insertion depth of the tines 42 into the ground can be adjusted by adjusting the height of the support roller 46. In the embodiment shown in FIGS. 6 and 7, the work implement 12 is designed without a support roller. Here, for example, no adjustment of the penetration depth is provided, or the penetration depth can be adjusted by means of a preferably contactless sensor (not shown) for detecting the position, in particular the height, of the work implement 12 relative to the ground and a control of the lifting height at a lifting actuator 48 taking place depending on the position thus detected.

In another embodiment, not shown in more detail here, the work implement 12 is designed as another work implement for lawn care, for example as a mowing deck, see the literature reference [8], which shows a possible embodiment of a work implement designed as a mowing deck.

In order to drive the soil cultivation appliance 10 to the point of use or to transport it between two points of use or to drive it back to a base, the work implement 12 can be raised to the raised position shown in FIG. 1, FIG. 5, and FIG. 6 in a transport mode. Thus, the work implement 12 has a greater distance to the ground 18 so that neither the piercing tools 40 nor the road surface are affected during transport. In conventional soil cultivation appliances 10 of this type, the center of gravity is shifted backwards in this raised position, so that the swivel wheel 22 or the other support element provided for stabilization is relieved and more weight is placed on the drive axle 20. In the working operation—working mode—shown in FIGS. 2-4, the work implement linkage 14 is operated in a floating position so that the work implement 12 can follow changes in the slope of the ground 18 and thus assume different vertical positions relative to the chassis 16 shown in FIGS. 2-4. Even with these different positions, the center of gravity of conventional soil cultivation appliances 10 changes so that different loads are applied to the drive axle 20. With different loads on the drive axle, slippage can occur on the individual drive wheels 24, or the drive wheels 24 can put too much load on the ground 18. Furthermore, in soil cultivation appliances 10, depending on the position of the work implement 12, there are different distances between the input shaft 34 and the output shaft 32, which must be compensated for by the power transmission means 36. In order to lift the entire load of the work implement 12, the lifting actuator 48 for lifting the work implement 12 in conventional soil cultivation appliances must be dimensioned accordingly.

In contrast, in the soil cultivation appliance 10 according to the embodiments shown, the drive unit 30 is mounted with at least one directional component so as to be vertically movable on the chassis 16 and is coupled to the work implement 12 or—in the embodiments shown here—more precisely to the work implement linkage 14 in such a way that the drive unit 30 serves as a counterweight for the movement of the work implement 12.

In preferred embodiments of the soil cultivation appliance 10, a rocker structure 50 is provided for this purpose, which is hinged to the chassis 16 so as to be pivotable about at least one substantially horizontal rocker axis 52, 54 extending transversely to the direction of travel.

In the first embodiment shown in FIGS. 1-4 and the third embodiment shown in FIGS. 5 and 6, a rocker axle 52 is provided, and the rocker structure 50 has a rocker frame 56 that can be pivoted as a whole about the rocker axle 52 and acts as a two-armed lever 72. At one end of the rocker frame 56, which is arranged at the rear here, the work implement linkage 14, which is designed, for example, as a triangular linkage, is arranged, while the drive unit 30 is arranged at the other end of the rocker frame 56, which is provided at the front here.

If the rocker frame 56 is moved by means of the lifting actuator 48 in such a way that the work implement 12 is raised, the drive unit 30 is lowered. If, on the other hand, the work implement 12 is lowered, the drive unit 30 is raised.

The output shaft 32 and the input shaft 34 are preferably engaged by frictional power transmission means 36. In the embodiments shown, a belt drive 58 is provided with at least one or more drive belts 60, 62 as power transmission means 36. Due to the joint movement of the drive unit 30 and the work implement 12 by means of the rocker construction 50, the distance between output shafts 32 or, in this case, the distance between axles of the belt drive 58 can be kept substantially the same. As a result, the tension of the individual drive belts 60, 62 remains the same, so that a uniform drive can be provided regardless of the position of the work implement 12.

Generally, the work implements 12 require much more energy than the traction motors 26 or the lifting actuator 48. Thus, it is currently preferred that the drive unit 30 includes an internal combustion engine 64 with a tank (not shown) or the like as an energy storage device. The output shaft 32 is the output shaft of the internal combustion engine 64. The traction motors 26 may be hydraulic motors, for example, in which case the internal combustion engine 64 also drives a pump for a hydraulic circuit. In this case, the lifting actuator 48 is preferably designed as a hydraulic cylinder. In the present preferred embodiment, the traction motors 26 are electric motors, and the lifting actuator 48 is formed as an electrically driven cylinder 66. Due to the fact that the drive unit 30 serves as a counterweight, the electrically operated cylinder 66 can be dimensioned accordingly small.

The drive unit 30 has a generator, not shown in detail here, driven by the internal combustion engine for power supply, and one or more batteries may also be provided as electrical energy storage devices (not shown).

Of course, other designs of the drive unit 30 are also conceivable, such as an electric motor-battery combination or the like.

Particularly in the embodiment with internal combustion engine 64, it is advantageous if the inclination positions of the drive unit 30 do not vary too much. It is also advantageous if the inclination of the work implement 12 does not vary or varies only slightly.

For this purpose, in the further embodiment shown in FIG. 5, the rocker construction 50 is provided with a parallelogram guide 68. The rocker construction 50 can have a first rocker 70, shown schematically in FIG. 5, which bears the main load and can be designed like the rocker frame 56. This first rocker 70 forms a first two-sided lever 72, to the first lever arm 74 of which the drive unit 30 is articulated, and to the second lever arm 76 of which the work implement linkage 14 and thus the work implement 12 is articulated.

The rocker structure 50 of the second embodiment shown in FIG. 5 further comprises a second two-sided lever 78, which is pivotally connected to the chassis 16 in a vertically offset manner on a second rocker axis 54, and whose first lever arm 80 is connected to the drive unit 30 in a vertically offset manner, while whose second lever arm 82 is connected to the work implement linkage 14, and thus to the work implement 12, in a vertically offset manner with respect to the second lever arm 76 of the first two-sided lever 72.

The third embodiment shown in FIGS. 6 and 7 corresponds to the first embodiment except for the omission of the support roller 46 and the replacement of its function by a control of the lifting height at the lifting actuator 48. The control can be implemented as software in an electronic controller (not shown). For this purpose, a preferably non-contact distance sensor may be provided for detecting the distance of the work implement 12 from the ground. Of course, a corresponding control could also be provided in the embodiment of the soil cultivation appliance 10 shown in FIG. 5, in which case the at least one support roller 46 can also be omitted.

Overall, the soil cultivation appliance 10—in all of the aforementioned embodiments—can be designed differently with regard to the position of an operator. In a version not shown in more detail here, the soil cultivation appliance 10 can have an operator stand or operator seat with operator interface, as described and shown, for example, in the literature reference [1]. It is also possible that the soil cultivation appliance 10 is equipped with a handle or similar operator interface for a person travelling with the soil cultivation appliance 10, as is known from the literature reference [2]. Particularly preferred in the embodiments of the soil cultivation appliance 10 shown is a control system for controlling the drive unit 30, the travel motors 26 and the lifting actuator 48, as well as other further actuators or devices of the soil cultivation appliance 10, which is not shown in more detail here and which has a remote control receiver or a wireless transceiver device and can be operated by an operator by means of a remote control not shown here.

### LIST OF REFERENCE SIGNS

10 soil cultivation appliance
12 work implement
14 work implement linkage
16 chassis
18 ground
20 drive axle
22 pivot wheel
24 drive wheel
26 drive motor
28 swivel axis
30 drive unit
32 output shaft
34 input shaft
36 power transmission means
38 deep aerator
40 piercing tools
42 tine
44 Support arm
46 Support roller
48 lifting actuator
50 Rocker structure
52 first rocker axle
54 second rocker axle
56 rocker frame
58 belt drive
60 first drive belt
62 second drive belt
64 combustion engine
66 electrically operated cylinder
68 parallelogram guide
70 swing arm
72 first two-sided lever
74 first lever arm (first lever)
76 second lever arm (first lever)
78 second two-sided lever
80 first lever arm (second lever)
82 second lever arm (second lever)

1. A mobile soil cultivation appliance, comprising:
a chassis with at least one drive axle for driving a travel movement of the soil cultivation appliance over the soil;
a drive unit with an output shaft; and
a work implement which is configured to be ascended and descended relative to the chassis and includes a drive shaft and at least one soil working tool which is movable for soil working upon rotation of the drive shaft,
wherein the drive shaft is connected to the output shaft by means of a power transmission means to allow the drive shaft to be driven by the drive unit, and
wherein the drive unit is connected to the work implement as a counterweight for the work implement in such a way that the drive unit descends when the work implement is ascended and ascends when the work implement is descended.

2. The appliance according to claim 1,
2.1 wherein the drive axle includes a first and a second drive wheel and is connected to a travel drive unit which is configured to drive the first and the second drive wheel at different speeds and/or in the same or different directions of rotation, and/or
2.2 wherein the chassis includes at least one swivel wheel which is arranged at a distance from the drive axle with respect to a direction of travel; and/or
2.3 wherein the drive shaft is driven by means of at least one drive motor implemented as an electric motor or hydraulic motor.

3. The appliance according to claim 1, wherein the drive unit comprises at least one of the following subunits:
3.1 an internal combustion engine;
3.2 a fuel tank;
3.3 a rechargeable battery;
3.4 an electric motor;
3.5 a generator to produce electricity.

4. The appliance according to claim 1, wherein the work implement includes a row of piercing tools with tines which, driven by means of the drive shaft, are configured to be pricked into the ground and pulled out for aerating.

5. The appliance according to claim 1,
5.1 wherein the drive unit and the work implement or a work implement linkage for linking the work implement are arranged on different sides with respect to the drive axle and/or
5.2 wherein the drive unit and the work implement or a work implement linkage for linking the work implement are arranged on a rocker structure, which is pivotably hinged to the chassis relative to the chassis.

6. The appliance according to claim 5, wherein the rocker structure comprises:
at least one first two-sided lever which is articulated to the chassis and to one lever arm of which the drive unit is articulated and to the other lever arm of which the work implement or the work implement linkage is articulated; and
a second two-sided lever which is articulated to the chassis at a vertical distance from the first two-sided lever, the first lever arm of which is articulated to the drive unit at a vertical distance from the first lever arm of the first two-sided lever and the second lever arm of which is articulated to the work implement or the work implement articulation thereof at a vertical distance from the second lever arm of the first two-sided lever.

7. The appliance according to claim 5, wherein an articulation axis, by means of which the rocker structure is articulated to the chassis, is arranged concentrically to a rotation axis of drive wheels of the drive axle or at a distance from the rotation axis of the drive wheels which is less than half, than one third or than one tenth of the distance between the rotation axis of the drive wheels and another axle or wheel of the chassis.

8. The appliance according to claim 1, wherein the power transmission means comprises at least one drive belt.

9. The appliance according to claim 1, further comprising:
a lifting actuator configured to ascend or descend the work implement and/or a work implement linkage, which is linked to the work implement.

10. The appliance according to claim 1, wherein the work implement comprises at least one support wheel or roller for supporting the work implement on the ground.
